(19) United States
(12) Patent Application Publication
(10) Pub. No.: US 2009/0083016 A1
(43) Pub. Date: Mar. 26, 2009

(54) Method for Generating a Calculation Model for a Mechanical Structure

(75) Inventors: Jurgen Veith, Mainz-Kostheim (DE); Udo Jankowski, Weisbaden (DE)

Correspondence Address: Michael L. Leetzow, Esq.;Michael L. Leetzow, P.A., 5213 SHORELINE CIRCLE, SANFORD, FL, 32771, US

(73) Assignee: TECOSIM Technische Simulation GmbH, Ruesselheim (DE)

(21) Appl. No.: 11/719,436

(22) PCT Filed: Nov. 7, 2005
(86) PCT No.: PCT/EP2005/011878

§ 371 Date: May 16, 2007

(30) Foreign Application Priority Data
Nov. 17, 2004 (EP) 04027277.5

(51) Int. Cl. G06F 17/50; G01B 11/24

(52) U.S. Cl. 703/8

(57) ABSTRACT

The invention concerns a method for generating a calculation model, in particular a finite element calculation model, for a mechanical structure, in particular a mechanical structure of a motor vehicle, such as a body-in-white, said method involving the following steps: a) preparing the mechanical structure from which a calculation model is to be generated; b) cleaning the mechanical structure; c) applying reference points to the cleaned and assembled mechanical structure; d) scanning the assembled mechanical structure in order to generate geometric data pertaining to the assembled mechanical structure, from the individual parts of the assembled mechanical structure and the reference points; e) at least partly dividing the assembled mechanical structure into individual parts, which cannot be completely detected when scanning the assembled mechanical structure; f) scanning the individual parts alone or in conjunction with at least one add-on part attached to each individual part in order to generate corresponding geometric data; g) converting the geometric data into a calculation model for the mechanical structure.

The invention relates to a method for generating a calculation mode, in particular a finite element calculation model, for a mechanical structure, in particular a mechanical structure of a motor vehicle such as a body shell.

In the development of new products, virtual product development based on calculation models or simulation models has already become established in practice. For example, the development of new mechanical structures, for example new bodywork structures, is therefore carried out on the basis of computer-supported CAD design environments, it being possible to use software which is already available to convert the CAD design data generated in such a CAD design environment into finite element calculation models in order to simulate the behavior of the newly developed product under a wide variety of conditions in a virtual fashion. For example, the applicant therefore markets a computer program under the product name “TEC|ODM” for automatically generating finite element calculation models from CAD design data which is generated in a CAD design environment. Such calculation models can be used to simplify and speed up the development of new products.

Although what is referred to as a virtual product development has already become established in the development of new products, the comparison or the benchmarking of existing products or newly developed products with competing products is still always done using the specific hardware and thus using a real product. If, for example in the car industry, the behavior of a newly developed body shell is to be compared with the behavior of a body shell of a competing product in the course of a benchmarking process, to do this a body shell of a competing product is acquired and trials are performed on the real product in order to compare the manufacturer's own product with the competing product, until now, no approach for carrying out benchmarking with competing products in a virtual fashion has been known from the prior art. This is due, inter alia, to the fact that CAD design data on competing products is not available and therefore it is also impossible to generate a calculation model or simulation model from such CAD design data.

Taking this as a basis, the present invention is based on the problem of providing a novel method for generating a calculation model for a mechanical structure.

This problem is solved by means of a method for generating a calculation model for a mechanical structure having the features of claim 1. According to the invention, the invention comprises at least the following steps: a) the mechanical structure of which a calculation model is to be generated is made available; b) the mechanical structure is cleaned; c) the reference points are applied to the cleaned and assembled mechanical structure; d) the assembled mechanical structure is scanned in order to generate geometry data on the assembled mechanical structure of individual parts of the assembled mechanical structure and the reference points; e) at least partial dismantling of the assembled mechanical structure into individual parts which cannot be completely scanned during the scanning of the assembled mechanical structure; f) scanning of the individual parts alone or in conjunction with at least one add-on part of the respective individual part in order to generate corresponding geometry data; and g) conversion of the geometry data into a calculation model of the mechanical structure.

The present invention proposes for the first time a method for generating a digital calculation model by means of a real product, specifically a real mechanical structure, in order to be able to carry out virtual benchmarking. As a result, a virtual calculation model or simulation model can be generated without CAD design data on the competing product having to be available.

By scanning or digitizing the real mechanical structure using photogrammetric methods it is possible to acquire geometry data on said structure. The geometry data is converted in an automated fashion into a virtual calculation model or simulation model. According to a first alternative, the geometry data is converted directly into the calculation model or simulation model in an automated fashion. According to a second alternative, the geometry data is first converted in an automated fashion into surface data and thus converted into CAD data, a virtual calculation model or simulation model of the mechanical structure then being generated in an automated fashion from the surface data or CAD data.

Accordingly, the invention can use real products from a competitor to generate a virtual calculation model of this product in an automated fashion so that when a new product is developed virtual benchmarking with competing products can already be carried out in early development phases. This opens up completely new possibilities in product development.

When scanning using photogrammetric methods, the mechanical structure is firstly digitized as an assembled unit, the mechanical structure being at least partially dismantled after the scanning or digitization of the assembled unit, in order to digitize individual parts of the mechanical structure which cannot be scanned completely during the scanning of the assembled unit as individual parts or in conjunction with at least one add-on part of the respective individual part using photogrammetric methods. The calculation model of the mechanical structure, specifically a three-dimensional CAE calculation model, preferably a three-dimensional finite element calculation model, is then generated from the geometry data acquired during the scanning of the assembled unit and the geometry data acquired during the scanning of the individual parts and, if appropriate, add-on parts.

The method according to the invention is preferably used for generating a finite element calculation model for a mechanical structure of a motor vehicle, specifically of a body shell of the motor vehicle.

Preferred developments of the invention emerge from the subclaims and the following description. An exemplary embodiment of the invention is explained in more detail below with reference to the drawing, without there being a restriction to said exemplary embodiment, in the drawing:

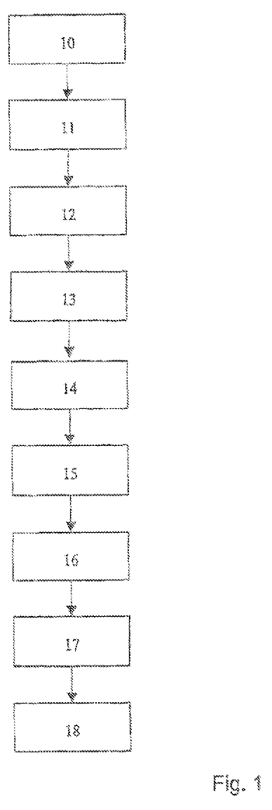

FIG. 1 is a block circuit diagram of the method according to the invention for generating a calculation model for a mechanical structure.

The method according to the invention is described in greater detail below with reference to FIG. 1. It is to be assumed here that the method according to the invention is to be used to generate a virtual calculation model of a body shell of a motor vehicle. However, even at this point it is to be noted that the method according to the invention is not restricted to use in the car industry. Instead, it can be used wherever a virtual calculation model is to be generated from a real mechanical structure for the purpose of virtual benchmarking.

In order to generate a virtual calculation model of a body shell of a motor vehicle, the procedure according to the present invention is that in a first step 10 of the method according to the invention the body shell of which a calculation model is to be generated is made available as a real mechanical structure. Such a body shell is also referred to as a body in white (BIW for short).

Then, in the sense of step 11, the body shell which is made available is cleaned down to the bare sheet metal by, for example, removing wax substances and sealing substances from the body shell. Furthermore, sealing materials and possibly present sound absorbing mats are removed from the body shell. The body shell is preferably cleaned here in an acid bath or lye bath.

The body shell which has been cleaned and from which, if appropriate, sealing materials and sound absorbing materials have been removed then has reference points applied to it, within the sense of step 12, in order to mark the relative position between the selected points or regions of the body shell. The reference points can be applied at any desired locations or positions on the body shell.

Thus, within the sense of step 13, the body shell which has been made available and cleaned and marked with reference points is digitized as an assembled unit by scanning using photogrammetric methods. During the scanning of the assembled unit, what is referred to as digital geometry data is acquired on the assembled body shell, and digital geometry data is acquired on individual parts of the assembled body shell. Furthermore, during the scanning of the assembled body shell, digital geometry data on the reference points and digital geometry data on connecting points of the assembled body shell is acquired. These connecting points are, for example, weld points and/or weld seams and/or rivet points and/or screwed connections and/or bonding points of the assembled body shell which is composed of a plurality of individual parts. Furthermore, during the scanning of the assembled body shell, digital geometry data on material thicknesses or sheet metal thicknesses is acquired.

Subsequent to the scanning or digitization of the assembled unit or of the assembled body shell within the sense of step 13, the assembled body shell is at least partially dismantled in step 14 of the method according to the invention. In the process, screwed connections are disconnected. Weld points or weld seams or else rivet points or bonding points are disconnected. The dismantling of the assembled body shell is done in such a way that individual parts of the body shell which are entirely or partially covered in the assembled state of said body shell, and accordingly cannot be scanned or can only be scanned incompletely during the scanning of the assembled body shell, can be scanned after the dismantling within the sense of step 14 in a subsequent step 15.

In step 15, individual parts or individual parts in conjunction with at least one add-on part which cannot be, or can only be incompletely, scanned and accordingly digitised during the scanning of the assembled body shell are scanned separately using photogrammetric methods in order also to acquire digital geometry data for those individual parts. This data is again digital geometry data on the individual parts and, if appropriate, on the add-on parts and digital geometry data on connecting points where the individual parts are connected to the add-on parts, and digital geometry data on material thicknesses.

Accordingly, as a result of step 13, the abovementioned, digital geometry data on the assembled body shell is available, and as a result of step 15 the abovementioned, digital geometry data on individual parts and, if appropriate, add-on parts of these individual parts which cannot be scanned completely during the scanning of the assembled body shell in step 13 is available. By means of the geometry data on the reference points which is acquired during the scanning and the connecting points, the geometry data on the individual parts which is generated in step 15 is linked in an unambiguous, automated fashion with the geometry data on the assembled body shell which is generated in step 13.

The scanning is carried out optically using a photogrammetric method. During the scanning, what are referred to as clouds of points of the mechanical structure to be scanned or on individual parts of the mechanical structure to be scanned are generated as digital geometry data.

Then, within the sense of step 16, the geometry data items which have been acquired during the scanning in steps 13 and 15 and logically combined with one another are converted in an automated fashion using commercially available software into surface data, and thus into three-dimensional CAD data. This can be done, for example, using the “GEOMAGIC” or “ICEM” or “TEBIS” software from the manufacturers of the same name.

The surface data or CAD data which is acquired in step 16 is then converted within the sense of step 17 in an automated fashion into a virtual calculation model or simulation model of the body shell, specifically into a CAE calculation model, preferably into a three-dimensional finite element calculation model. The automatic conversion of the CAD data into a finite element calculation model can be done, for example, using the “TEC|ODM” product which has been developed and is marketed by the applicant.

Accordingly, as a result of step 17, a virtual calculation model or simulation model of the real body shell which was made available in step 10 is available without having to access design data on the body shell. This permits virtual calculation models to be generated from any desired products, thus allowing virtual benchmarking during product development.

It is to be noted that geometry data items which have been acquired during the scanning and logically combined with one another can also be used to directly generate a virtual calculation model or simulation model of the body shell.

In this case, the geometry data is not converted into surface data or into three-dimensional CAD data but rather said geometry data is converted directly into the calculation model or simulation model in an automated fashion. The geometry data items which have been acquired during the scanning and logically combined with one another can be converted directly and in an automated fashion into a finite element calculation model by using, for example, the “TEC|ODM” product which has been developed and is marketed by the applicant.

Subsequent to step 17, the generated, virtual calculation model can be integrated, within the sense of step 18, into a simulation environment in which input variables for the virtual calculation model can be generated in an automated fashion. This is carried out, for example, using the product which has been developed and is marketed by the applicant under the product name “TEC|PROM”. The virtual calculation model of the body shell can be linked in step 18 with further data which is relevant for the simulation. This data may be, for example, material data for the individual parts of the body shell.

### LIST OF REFERENCE NUMERALS

10 Step
11 Step
12 Step
13 Step
14 Step
15 Step
16 Step
17 Step
18 Step

1-13. (canceled)

14. A method for generating a calculation model, in particular a finite element calculation model for a mechanical structure which is composed of a plurality of individual parts, in particular a mechanical structure of a motor vehicle such as a body shell, having the following steps:
a) providing the mechanical structure of which a calculation model is to be generated;
b) cleaning the mechanical structure;
c) applying reference points to the cleaned and assembled mechanical structure;
d) scanning the assembled mechanical structure to generate geometry data relating to the assembled mechanical structure, including individual parts of the assembled mechanical structure and the reference points;
e) at least partially dismantling the assembled mechanical structure into individual parts that cannot be completely scanned during the scanning of the assembled mechanical structure;
f) scanning of the individual parts to generate corresponding geometry data; and
g) converting the geometry data into a calculation model of the mechanical structure.

15. The method as claimed in claim 14, wherein the step of converting the geometry data further includes the steps of:
converting the geometry data in an automated fashion into surface data; and
converting the surface data in an automated fashion into the calculation model.

16. The method as claimed in claim 14, wherein the step of converting the geometry data includes converting the geometry data directly into the calculation model in an automated fashion.

17. The method as claimed in claim 14, wherein the step of cleaning the mechanical structure includes cleaning the mechanical structure down to the bare sheet metal.

18. The method as claimed in claim 17, wherein the step of cleaning the mechanical structure includes removing substances that include at least one of wax materials, sealing substances, sealing materials, and sound absorbing mats.

19. The method as claimed in claim 14, wherein the step of scanning the assembled structure includes recording geometry data relating to connecting points, the connecting including at least one of weld points, weld seams, rivet points, screwed connections, and bonding points.

20. The method as claimed in claim 19 wherein the step of scanning the assembled structure includes recording geometry data relating to material thicknesses of the mechanical structure.

21. The method as claimed in claim 14, wherein the step of scanning individual parts includes recording geometry data relating to the respective individual part and any add-on part.

22. The method as claimed in claim 21, wherein the step of scanning also includes recording geometry data relating to at least one of connecting points and material thicknesses.

23. The method as claimed in claim 14, wherein the scanning steps are carried out using photogrammetric methods.

24. The method as claimed in claim 14, wherein the calculation model includes a three-dimensional finite element calculation model.

25. The method as claimed in claim 19, further comprising the steps of combining the geometry data items relating to the assembled mechanical structure acquired during the scanning of the assembled mechanical structures and the geometry data items relating to the individual parts acquired during the scanning of the individual parts by means of geometry data relating to the reference points acquired during the scanning of the connecting points prior to conversion into the calculation model.

26. A method for generating a finite element calculation model for a body shell of a motor vehicle which is composed of a plurality of individual parts, having the following steps:
a) providing the body shell of which a calculation model is to be generated;
b) cleaning the body shell down to the bare sheet metal, whereby all wax materials, sealing substances, sealing materials, and sound absorbing mats are removed from the body shell of the motor vehicle;
c) applying reference points applied to the cleaned and assembled body shell;
d) scanning the assembled body shell to generate geometry data relating to the assembled body shell, individual parts of the assembled body shell and the reference points, whereby geometry data relating to connecting points of the body shell are also recorded during the scanning of the assembled body shell, the connecting points including at least one of weld points, weld seams, rivet points, screwed connections, and bonding points, and whereby geometry data relating to material thicknesses of the body shell are also recorded during the scanning of the assembled body shell;
e) at least partially dismantling the assembled body shell into individual parts that cannot be completely scanned during the scanning of the assembled body shell;
f) scanning of individual parts to generate corresponding geometry data, whereby the individual part may also include at least one add-on part of the respective individual part and recording the geometry data relating to the respective individual part; and
g) combining the geometry data items relating to the assembled body shell acquired during the scanning of the assembled body shell with the geometry data items relating to the individual parts acquired during the scanning of the individual parts by means of geometry data relating to the reference points acquired during the scanning of the connecting points, to generate a three-dimensional finite element calculation model from the geometry data by conversion of the geometry data in an automated fashion into a calculation model of the body shell.

27. The method as claimed in claim 26, wherein the step of combining the geometry data is firstly converted in an automated fashion into surface data, and in that the surface data is then converted in an automated fashion into the calculation model.

28. The method as claimed in claim 26, wherein the step of combining the geometry data is converted directly into the calculation model in an automated fashion.

29. The method as claimed in claim 26, wherein the step of scanning the individual parts includes recording process geometry data relating to at least one of connecting points and material thicknesses.

30. The method as claimed in claim 26, wherein the scanning steps are carried out using photogrammetric methods.
